(19) United States
(12) Patent Application Publication
(10) Pub. No.: US 2018/0199200 A1
(43) Pub. Date: Jul. 12, 2018

(54) LOCATION-BASED AUTHENTICATION

(71) Applicant: Microsoft Technology Licensing, LLC, Redmond, WA (US)

(72) Inventors: Bin Wang, Bellevue, WA (US); Ying Chin, Bellevue, WA (US); Pengxiang Zhao, Bellevue, WA (US); Robert Zhu, Bellevue, WA (US); Dejun Zhang, Redmond, WA (US); Satyendra Bahadur, Yarrow Point, WA (US); Daryl A. Welsh, Bellevue, WA (US)

(21) Appl. No.: 15/405,037

(22) Filed: Jan. 12, 2017

(51) Int. Cl. H04W 12/08; H04L 29/06; H04W 12/06; H04W 4/02

(52) U.S. Cl. CPC H04W 12/08; H04L 63/107; H04W 4/02; H04W 12/06; H04L 63/083

(57) ABSTRACT

An electronic device includes a location detector configured to determine a current device location and a location-based access controller configured to determine whether the current device location satisfies at least one predefined secure location criteria and to selectively preserve or disable a current user authentication session based on the determination.

### BACKGROUND

Some mobile electronic devices include security features that condition data access on receipt and authentication of credentials from a user. For example, an electronic device may prompt a user for authentication prior to granting the user access to stored device information. Authentication is, in some cases, requested responsive to detection of certain trigger events, such as when a device awakes from a low power mode or responsive to a user attempt to use the device for a specific purpose (e.g., when the user attempts to pay for a product at a store using a digital wallet technology). Frequent authentication requests can be annoying to a user, especially in circumstances where the user feels that the security risk is low, such as when the user is in his own home. Solutions for relaxing such security measures to improve user convenience typically also increase the risk of data misappropriation.

Many mobile devices implementing authentication-based access features also implement energy saving features. Reducing battery consumption while maximizing the user experience is a key challenge, as the range of utility provided by mobile devices continues to expand. To save power, some devices include a feature that places a primary display into a sleep mode during periods of user inactivity. The primary display may, for example, be awakened from sleep mode by an affirmative user action, such as a tap of a button, flick of the wrist (in the case of some smart watches), voice command, or other user action. This power-saving sleep mode feature impedes device utility by providing periods of time when the display does not present any useful information. In the case of watches, this power-saving feature diminishes a quintessential utility of a traditional watch—the ability to decipher the time by merely glancing at the display without having to provide input to light up the screen.

### SUMMARY

Implementations described and claimed herein provide an energy-efficient processing device. In one implementation, the processing device includes a location tracker configured to identify a current device location and a location-based access controller configured to determine whether a current device location satisfies at least one predefined secure location criteria. The location-based access controller selectively preserves or disables a current user authentication session based the determination.

According to another implementation, an energy-efficient processing device disclosed herein includes a low-energy-consumption display configured to display first information and a transparent high-energy-consumption display positioned with an area overlapping the low-energy-consumption display to facilitate viewing the first information through the area when the transparent high-energy-consumption display is in a sleep mode.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates one example mobile processing device with a number of energy-saving features including location-based authentication.

FIG. 2 illustrates another mobile processing device with features for location-based device authentication.

FIG. 3 illustrates example operations for performing location-based authentication on a mobile processing device.

FIG. 4A illustrates a watch with a low-energy buckle attachment detection feature usable to trigger location-based authentication.

FIG. 4B illustrates another watch with another low-energy buckle attachment detection feature usable to trigger location-based authentication.

FIG. 4C illustrates yet another watch with another low-energy buckle attachment detection feature usable to trigger location-based authentication.

FIG. 5 illustrates an example mobile processing device that includes an energy-efficient dual display feature that facilitates continuous display of information at a low energy consumption rate.

FIG. 6 illustrates another example mobile processing device that includes an energy-efficient dual display feature that facilitates continuous display of information at a low energy consumption rate.

FIG. 7 illustrates an example schematic of a mobile processing device suitable for implementing aspects of the disclosed technology.

### DETAILED DESCRIPTION

Location data can be indicative of a relative degree of current risk posed to sensitive data stored on a mobile processing device. For example, the risk that an unauthorized person may access sensitive data on a user's laptop may increase dramatically when the laptop is used in a public place as compared to when the laptop is used in a private place, such as a user's home or a secure workplace. For this reason, a user may feel inconvenienced if repeatedly prompted for authentication input (e.g., a passcode) while exclusively using the mobile processing device in a secure, private space, such as at home, work, or in a secure hotel room. Decreasing the frequency of authentication prompts may decrease user inconvenience, but can also increase the risk of data misappropriation by an unauthorized party. For example, if a mobile processing device is left unattended in a public space and a current user authentication session is not disabled, a malicious party may be able to utilize digital wallet technology on the mobile processing device to make unauthorized purchases.

The herein disclosed technology addresses the forgoing by implementing location-based device authentication that provides robust data security while mitigating instances of user authentication prompts that may inconvenience a user. Additionally, the disclosed technology provides techniques that facilitate time-appropriate invocations of the above-described user authentication prompts via energy-efficient use mode monitoring techniques. Further, other power-efficient features disclosed herein expand utility of the mobile processing device to further improve convenience and enjoyment of the user experience.

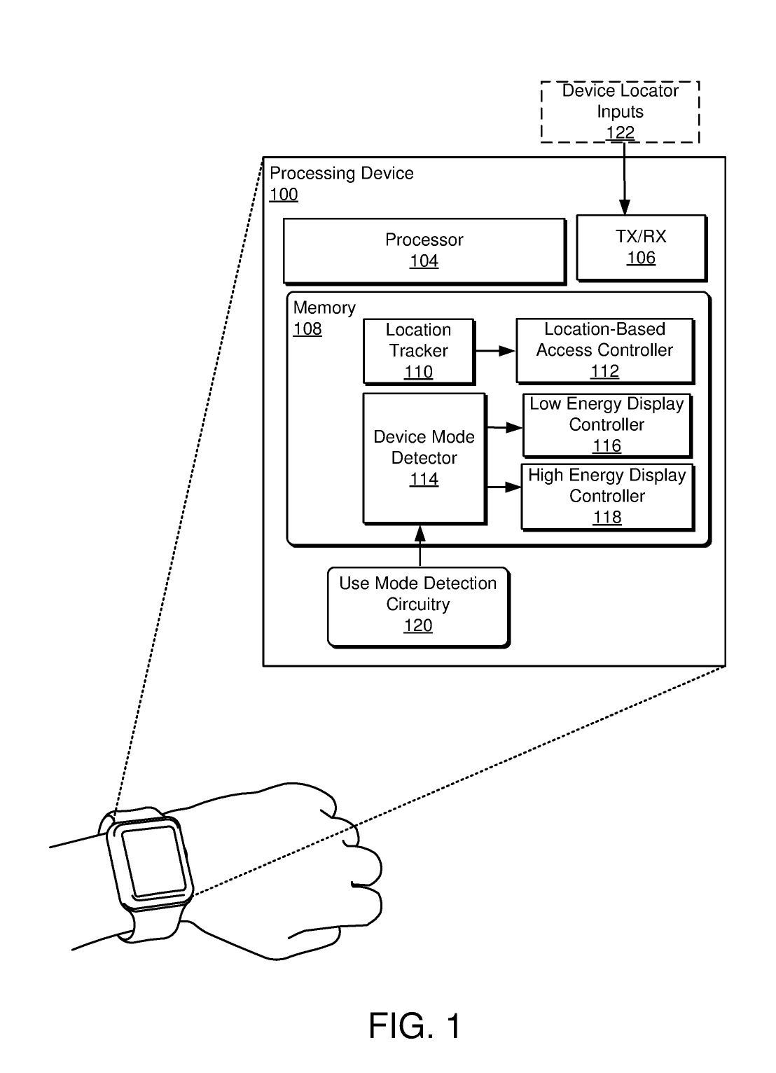

FIG. 1 illustrates one example mobile processing device 100 with a number of energy-efficient features including use mode monitoring for location-based authentication. In different implementations, the mobile processing device 100 may take on a variety of forms such as a mobile phone, tablet, personal computer, smart watch, or a variety of other processing devices. The mobile processing device 100 includes a processor 104 for executing an operating system (not shown) and one or more programs stored in memory 108, such as a location tracker 110, a device mode detector 114, a location-based access controller 112, and one or more display controllers such as an example low-energy display controller 116 and a high-energy display controller 118. The various components shown with respect to the mobile processing device 100 generally facilitate decreased power consumption and/or mitigate user inconveniences posed by authentication features without increasing vulnerability of the device to unauthorized access.

Although the memory 108 and processor 104 are shown internal to the mobile processing device 100, data herein described as stored within the memory 108 may, in some implementations, reside in whole or in part on one or more tangible computer media stored external to the mobile processing device 100. For example, some or all of the programs stored in memory (e.g., location tracker 110, the device mode detector 114, location-based access controller 112) may be stored external to the mobile processing device 100 and/or include functionality that is performed external to the mobile processing device 100, such as via an external processor that is communicatively coupled to the processor 104.

The mobile processing device 100 further includes communication circuitry that facilitates communications across a wide-area network (WAN), such as a cellular network (e.g., 3G, 4G, LTE) and/or a local area network (LAN), such as a Wi-Fi network, a Bluetooth network, or radio communications network. Data transmission and receipt is accomplished using a receiver and transmitter (e.g., TX/RX 106).

In one implementation, the location tracker 110 and location-based access controller 112 are executable to provide location-based authentication of the mobile processing device 100, such as to provide increased security when a detected current location is indicative of increased security risk and/or to decrease security and the associated user inconveniences when a detected current location is indicative of a secure location of use. The location tracker 110 utilizes device locator inputs 122 to geographically track the current location of the mobile processing device 100. The device locator inputs 122 may include different types of location data in various implementations of use. In one implementation, the location tracker 110 includes a global positioning system (GPS) (not shown) for receiving geographical coordinates from GPS satellites. Additionally and/or alternatively, the location tracker 110 may include circuitry for communicating with other devices across a local area network to infer location information, such as by analyzing identity information from a local Wi-Fi router, one or more discoverable Bluetooth devices, etc.

In one implementation, the location tracker 110 determines the current location of the mobile processing device 100 based on micro-location inputs received from a networked configuration of receiving elements (“reference points”) configured to continuously monitor signals emitted from the mobile processing device 100. For example, the reference points may be distributed about a business campus or office building. The reference points detect relative strengths of the signal from the mobile processing device 100, and the location tracker 110 then determines real-time locations (e.g., “micro-locations”) of the mobile processing device 100 based on the relative signal strength received at each reference point, such as by using triangulation in relation to the reference point locations.

In another implementation, the location tracker 110 determines the current location of the mobile processing device 100 based on micro-location inputs in the form of signals emitted from stationary beacons (e.g., a wireless signal such as Bluetooth or Wi-Fi), such as beacons distributed throughout a business campus, office building, etc. For example, the location tracker 110 may analyze signals received from the active beacons to determine a micro-location (e.g., via triangulation) of the mobile processing device 100.

The location-based access controller 112 receives current device location information from the location tracker 110 and uses the current device location information to determine whether to selectively disable or preserve a current user authentication session. In various implementations, this current device location information may be received continuously (e.g., responsive to each detected update in device position), periodically (e.g., at predefined time intervals), upon request, or responsive to certain trigger events (e.g., when the device exits a sleep mode). As used herein, a “user authentication session” may generally refer to a time period in which the mobile processing device 100 allows a user to access device information without a re-provisioning of authentication credentials. For example, an initial authentication of user credentials facilitates user access to information on the mobile processing device 100 for an entire authentication session, such as according to profile settings of an individual user. Certain events may terminate an authentication session and a new authentication session can be initiated when a user provides credentials (e.g., via voice input, photo recognition, fingerprint scan, passcode entry) and those credentials are again authenticated.

To determine whether to selectively disable or preserve a current user authentication session, the location-based access controller 112 determines whether a current device location satisfies one or more predefined secure location criteria. For example, a predefined secure location criterion may be satisfied when the detected current location corresponds to a location that is predesignated in the memory 108 as a “secure” location. For example, a user may update profile or biographical information stored on the mobile processing device 100 to define the user's home as a safe location. In another implementation, a device administrator (e.g., an employer) may initially configure the location-based access controller 112 to recognize one or more locations (e.g., certain buildings, offices, floors) as secure locations. In still other implementations, the location-based access controller is preconfigured to identify secure and unsecure locations in real-time, such as by using mapping data and/or various databases to identify and distinguish public places, such as restaurants, parks, and libraries, from private places that are more likely to be secure, such as private residences, office buildings, and private hotel rooms.

If the location-based access controller 112 determines that a detected current device location does not satisfy one or more predefined secure location criteria, the location-based access controller 112 may selectively disable a current user authentication session. In contrast, when the one or more predefined secure location criteria is satisfied, the location-based access controller 112 may elect to preserve an existing user authentication session rather than prompt a user for new authentication credentials. For example, the location-based access controller 112 disables a current user authentication session responsive to a determination that the current location of the mobile processing device 100 does not correspond to a predefined secure location.

The location-based access controller 112 may determine whether to selectively preserve or disable a current user authentication session differently in different implementations. In one implementation, the determination to preserve or disable a user authentication session is performed responsive to a detected change in location that satisfies one or more location change criteria. In another implementation, the determination to preserve or disable a user authentication session is performed responsive to a detected power level change (e.g., exiting sleep mode, powering on) of the mobile processing device 100. In yet another implementation, the determination to preserve or disable a user authentication session is performed responsive to a detected change in the current physical arrangement of the mobile processing device 100 that is detected by the device mode detector 114.

In general, the device mode detector 114 controls use mode detection circuitry 120 to collect information about how the mobile processing device 100 is physically arranged relative to an external environment. If, for example, the mobile processing device 100 is a smart watch (as shown), the device mode detector 114 may collect sensor inputs that indicate whether the watch is currently being worn, such as by detecting whether the ends of a band of the watch are attached to one another or are free. If, alternatively, the mobile processing device 100 is a laptop, the device mode detector 114 may collect sensor inputs from the use mode detection circuitry 120 indicating whether the laptop is open or closed. This use mode detection and related location-based authentication technology is extendable to a variety of technologies with other detectable use modes readily appreciated by those of skill in the art.

In one implementation, the location-based access controller 112 determines whether to selectively preserve or disable a current user authentication session responsive to input from the device mode detector 114 indicating a change in the use mode of the mobile processing device 100. If, for example, the processing device is a watch, this authentication determination may be made responsive to a detected attachment of the watch band to a user's wrist. If the mobile processing device 100 is a laptop, this authentication determination may be made responsive to a detected change in the physical configuration of the laptop from a closed position to an open position.

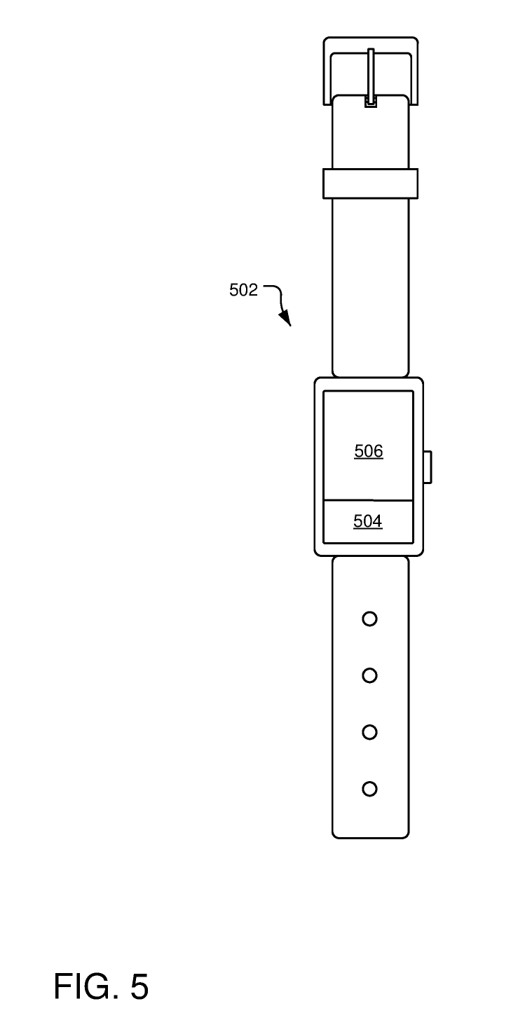

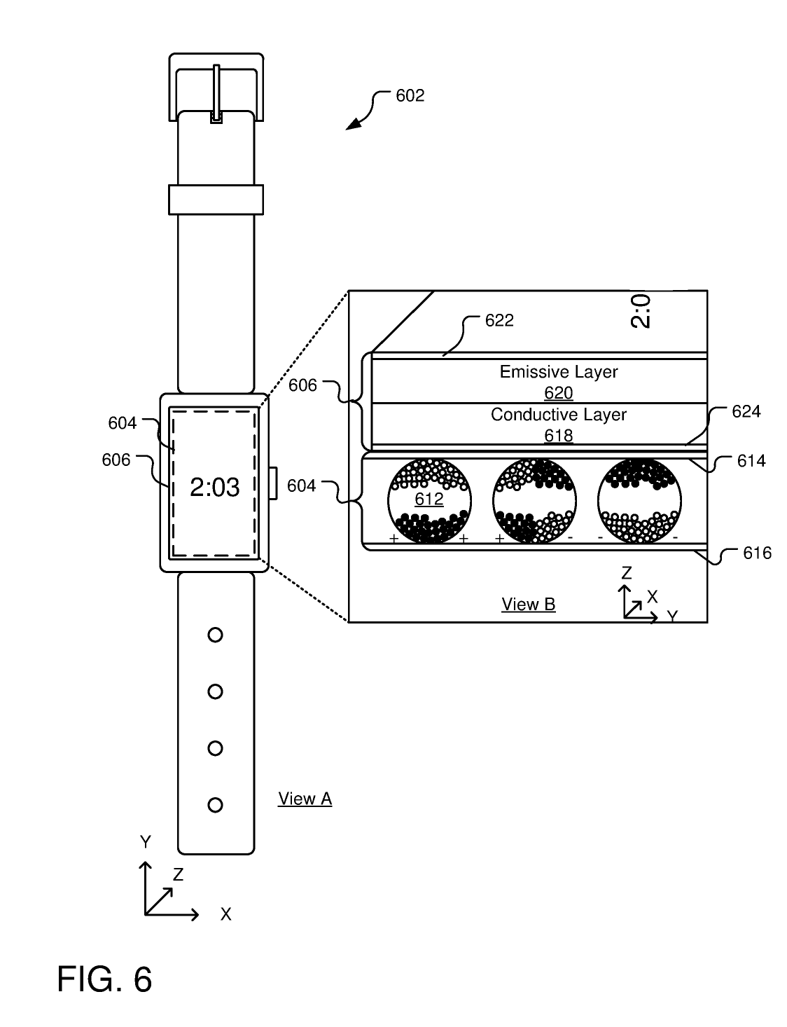

In addition to those features described above, the mobile processing device 100 may, in some implementations, include a dual-display feature that facilitates a continuous display of information at low energy consumption. The mobile processing device 100 is shown to include a low energy display controller 116 and a high-energy display controller 118 for independent powering and display control of dual displays. For example, the mobile processing device 100 may include a high-energy-consumption display (not shown) for displaying content at a high resolution and a low-energy-consumption display (not shown) for displaying content at a lower resolution. The high-energy-consumption display and the low-energy-consumption display may be situated adjacent to one another (e.g., as shown by displays 504 and 506 in FIG. 5), or in some cases, the high-energy-consumption display and the low-energy-consumption display are overlapping (e.g., as shown by displays 604 and 606 in FIG. 6).

In one implementation, the low-energy display controller 116 continuously displays information on a low-energy-consumption display while the high-energy display controller 118 selectively toggles a power setting of a high-energy-consumption display. For example, the low-energy-consumption display may be a display that does not emit light, such as an e-ink display, that is used to continuously display some information deemed important to the user (e.g., time, date, or other information). The high-energy-consumption display in contrast, may be a light-emitting display that is used primarily when a user is interacting with the mobile processing device 100.

One or both of the low-energy display controller 116 and the high-energy display controller 118 may receive inputs from the device mode detector 114. For example, device mode inputs may be used to determine when the user is actively interacting with the mobile processing device 100 so that the high-energy-consumption display can be powered down during periods when the user is not interacting with the mobile processing device 100. Projecting some information onto the low-energy-consumption display while the high-energy-consumption display is powered down (e.g., in a sleep mode) can increase utility of the device without a corresponding increase in battery drain.

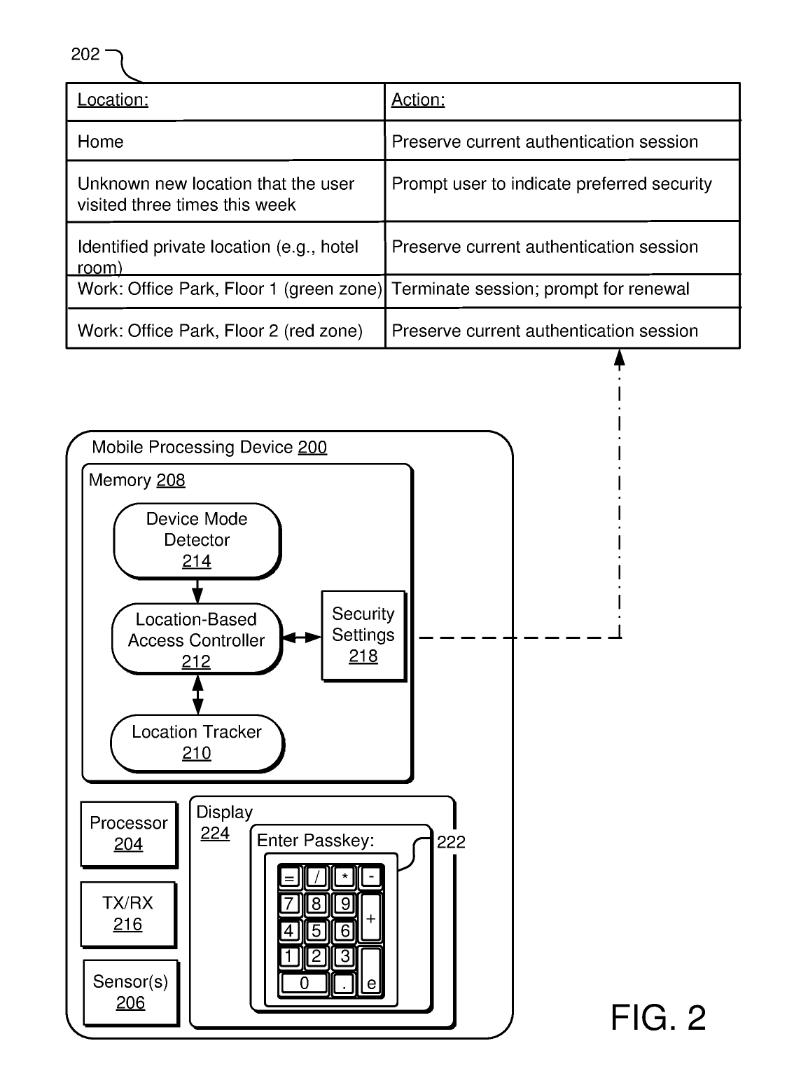

FIG. 2 illustrates a mobile processing device 200 with features for location-based device authentication. The mobile processing device 200 is readily transportable between different locations and may be a mobile phone, tablet, laptop computer, smart watch, other wearable electronic device, etc. The mobile processing device 200 includes a processor 204, memory 208, and a number of applications stored in the memory 208 and executable by the processor 204 to provide different functionality. Among these applications, the mobile device 200 includes a location-based access controller 212, a location tracker 210, and a device mode detector 214 that work together to provide location-based device authentication.

The location tracker 210 determines a current location of the mobile processing device 200 based on location inputs and provides inputs to the location-based access controller 212, which in turn identifies an appropriate security action or non-action to implement based on the current location. Example security actions include terminating a current user authentication session and/or prompting the user to provide authentication credentials. As used herein, a security non-action, in contrast, refers to an affirmative decision to take no intervening security action and thereby preserve an existing (e.g., current) user authentication session.

The location tracker 210 collects location inputs by way of transmitting/receiving circuitry TX/RX 216. The location inputs may take on a variety of forms in different implementations including any combination of location inputs described above with respect to FIG. 1. Using one or more of the location inputs, the location tracker 210 identifies a current geographical location of the mobile processing device 200 and provides location information including the identified geographical location to the location-based access controller 212 for assessment of potentially relevant security action(s) and implementation of such actions when relevant.

The location tracker 210 may collect and update the above-described location information continuously or periodically (e.g., updating once per minute, every 15 seconds, or some other predetermined interval). Updates to this location information are occasionally provided to the location-based access controller 212 for assessment of potential security actions. In one implementation, the location tracker 210 provides updated location information to the location-based access controller 212 responsive to detection of one or more defined “trigger events.” Upon receipt of the updated location information, the location-based access controller 212 determines an appropriate security action, such as whether to terminate the current user authentication session based on the updated location information.

For example, one “trigger event” may be the expiration of a user inactivity timer. If a user has not interacted with a device for a set period of time (e.g., 15 minutes), the device mode detector 214 may signal the location tracker 210 to provide the location information to the location-based access controller 212 to determine whether to terminate the current user authentication session based on the current device location. Another “trigger event” may be a detected change in a device location that satisfies a predetermined location change criteria, such as a detected location change that is greater than a few meters, tens of meters, etc. Still another “trigger event” may be a detected change in a power mode of the mobile processing device 200, such as when the mobile processing device 200 awakens from a sleep mode or is initially powered on.

In still other implementations of the mobile processing device 200, a “trigger event” is detected when the use mode detector 214 determines that there has been a change in a physical configuration of the mobile processing device 200 that corresponds to a predefined device configuration. For example, sensor(s) 206 of the mobile processing device 200 may provide the device mode detector 214 with data usable to infer a change in physical device configuration, such as a detected increase in separation of a device display and keyboard (if the mobile processing device 200 is a laptop or a phablet) or a detected attachment or detachment of a smart watch wristband (if the mobile processing device 200 is a smart watch). Notably, some implementations of the mobile processing device 200 may not include the device mode detector 214.

Responsive to one or more trigger events, such as those described above, (e.g., the location-based access controller 212 accesses security settings to identify potentially-relevant security actions to implement based on the current device location). The security settings 218 may include various files and/or tables stored in the memory 208 or in an external memory readily accessible to the location-based access controller 212. By example and without limitation, FIG. 2 includes a location-based security settings table 202 that includes some information stored within or derivable from the security settings 218 of the mobile processing device 200. The example location-based security settings table 202 includes a listing of locations that are each associated with at least one security action or non-action.

Initial association of the various actions with locations in the location-based security settings table 202 may be performed differently in different implementations. In one implementation, a user is permitted to configure personal profile settings on the mobile processing device 200 to designate one or more locations as “secure,” such as the user's work or home where it may be desirable to relax certain security measures. For example, the location-based security settings table 202 includes a location identifier “home” that is associated in memory with identifying information, such as GPS coordinates of a user's home or information for identifying a wireless router or Bluetooth device known to reside in the user's home.

Responsive to a detected trigger event, the location-based access controller 212 compares the location information from the location tracker 210 to the identifying information stored in the location-based security settings table 202. When the location information from the location tracker 210 corresponds to the identifying information saved in association with a location identifier (e.g., the “home” location identifier), the location-based access controller 212 performs an associated action indicated by the “Action” column of the location-based security settings table 202. For example, the location-based access controller 212 may preserve the current authentication session rather than permitting the otherwise-scheduled interrupt of a current authentication session when the location-based access controller 212 determines that the current device location corresponds to “home.”

In some implementations, the location-based access controller 212 prompts the user to indicate whether a current device location is secure. For example, the location-based access controller 212 may query the user with a message: “is your current location a secure location? Press yes to automatically preserve log-in session information when at this location in the future. This action is recommended for private secure locations such as your work or home.” Such a prompt may, for example, be presented to the user when a new location satisfies criteria indicative of a secure location, such as when the location tracker 210 indicates that the current location is one that has been visited by the mobile processing device 200 with some threshold frequency, such as every day or multiple times in a week, month, etc.

In still other implementations, the mobile processing device 200 may be sold with pre-configured location-based security settings. For example, the location-based access controller 212 may be pre-configured to identify certain private locations as secure, such as when the micro-location indicates that the current location is a private hotel room. Such determinations may be based on mapping data stored in or otherwise accessible to the mobile processing device 200.

In still other implementations, a device administrator (e.g., a user's employer) may configure the location-based security settings table 202 to allow for automatic implementation of location-based security as a user transports the device to different locations within a place of employment, such as a business park. For example, a user's employer may configure certain “secure zones” so that increased security measures are implemented in certain areas of a business park such as common areas, e.g., a cafeteria, lobby, or low-security conference rooms.

The above-described “security zoning” concept is exemplified in FIG. 2 via an example location “Work: Office Park, Floor 1 (green zone)” in the location-based security settings table 202. The location “Work: Office Park, Floor 1 (green zone)” represents a low-security region in an office park, such as a common area open to the public or open to employees of many different departments. When a trigger event is detected at a time that the mobile processing device 200 is within this low-security region, the location-based access controller 212 identifies the region as unsecure and automatically terminates the user authentication session. The user may, for example, be presented with a prompt requesting that the user re-enter authentication credentials, such as by providing a passcode to an interface 222 on a display 224 of the mobile processing device 200.

The location-based security settings table 202 includes another example location “Work: Office Park, Floor 2 (red zone)” representing a high-security region in an office park, such as a region that restricts access to certain employees that is therefore unlikely to be frequented by malicious persons that do not have authentication credentials for the mobile processing device 200. When the mobile processing device 200 is detected within this high-security region, the location-based access controller 212 may recognize the region as secure and relax security of the device, such as by updating a setting to prevent interruptions to the user authentication session.

Although not shown in the location-based security settings table 202, the location-based access controller 212 may implement other increased security measures responsive to detection of a trigger event in an unsecure location. For example, a time-out interval may be decreased so that a device may terminate an authentication session more quickly during periods of user inactivity on the mobile processing device 200 so long as the mobile processing device 200 remains in the unsecure zone. When the mobile processing device 200 is subsequently detected in a secure location, the increased security measures may be relaxed.

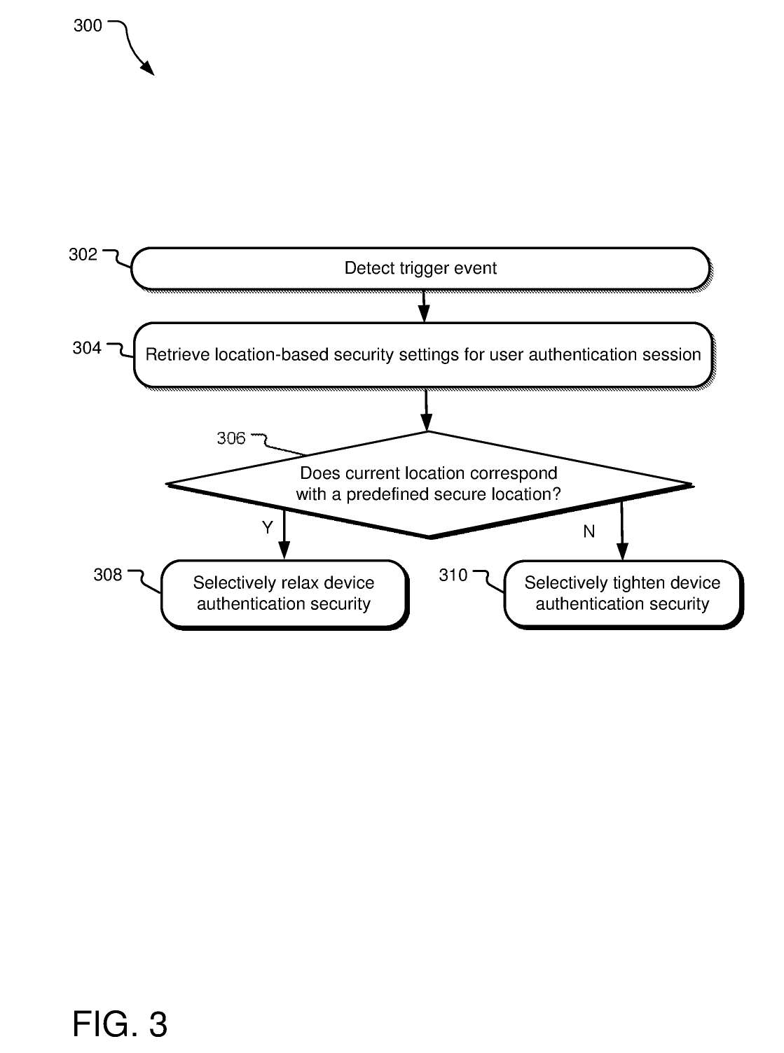

FIG. 3 illustrates example operations 300 performable by a mobile processing device to implement location-based authentication. A detection operation 302 detects a trigger event. Responsive to the detected trigger event, a retrieving operation 304 retrieves location-based security settings pertaining to a current user authentication session that may be used in a location-based security evaluation.

The trigger event of the detection operation 302 make take on a variety of different forms in different implementations. In one implementation, the trigger event is detected when a user inactivity timer expires. For example, the mobile processing device may be configured to interrupt a user authentication session under some conditions when the user has not interacted with the mobile processing device for a period of time, such as several minutes. In another implementation, the detected trigger event is a detected change in a physical configuration of the mobile processing device. If, for example, the mobile processing device is a smart watch including circuitry to detect when a band of the watch is attached or unattached to a user, attachment of the watch band may be a trigger event that triggers the retrieving operation 304. In still another implementation, the trigger event is a detected location change of the mobile processing device of a magnitude that satisfies one or more location change criteria. In yet another implementation, the detected trigger event is a change in a power mode of the mobile processing device, such as the mobile processing device waking from a sleep mode.

The retrieving operation 304 retrieves current security settings from the memory of the mobile processing device. The current security settings include location information for each of one or more locations previously-designated as “secure” locations.

A determination operation 306 compares a detected current location of the mobile processing device with location information for each one of the previously-designated secure locations. If the determination operation 306 determines that the current device location corresponds to one or more of the saved previously-designated secure locations, a security adjusting operation 308 relaxes one or more authentication security measures, thereby removing one or more protections against unauthorized access and/or decreasing stringency of one or more already-implemented protections against unauthorized access. For example, the security adjustment operation 308 may prevent interruption of the current authentication session until a trigger event is detected at a non-secure location. In another implementation, the security adjustment operation 308 alters a setting to lengthen the duration of a user authentication session time-out interval.

If, however, the determination operation 306 determines that the current device location does not correspond to one or more of the saved “secure” locations, a security adjustment operation 310 selectively tightens device security, thereby adding one or more protections against unauthorized access and/or increasing stringency of one or more already-implemented protections against unauthorized access. For example, the security adjustment operation 310 may automatically terminate the current user authentication session and prompt the user to re-enter authentication credentials before allowing the user to resume access to data on the mobile processing device. In another implementation, the security adjustment operation 310 alters one or more security settings to temporarily increase device security until another trigger event is detected when the mobile processing device is at one of the saved secure locations. For example, the security adjustment operation 310 may shorten the duration of a user authentication session time-out interval until the mobile processing device is again detected at a secure location.

In still another implementation, the security adjustment operation 310 selectively tightens a security setting to prompt a user for an additional level of authentication when the mobile processing device is not detected at one of the saved secure locations. For example, the user may be prompted for an authentication credential when the mobile processing device is detected at a saved secure location “home,” but prompted for an additional authentication credential when the mobile processing device is detected in a public location. In yet another implementation, the security adjustment operation 310 selectively tightens the level of security by dynamically adjusting a level of encryption between two mobile processing devices such that a more secure encryption scheme is implemented when one or both of the mobile processing devices is detected at a location that does not correspond to a saved secure location.

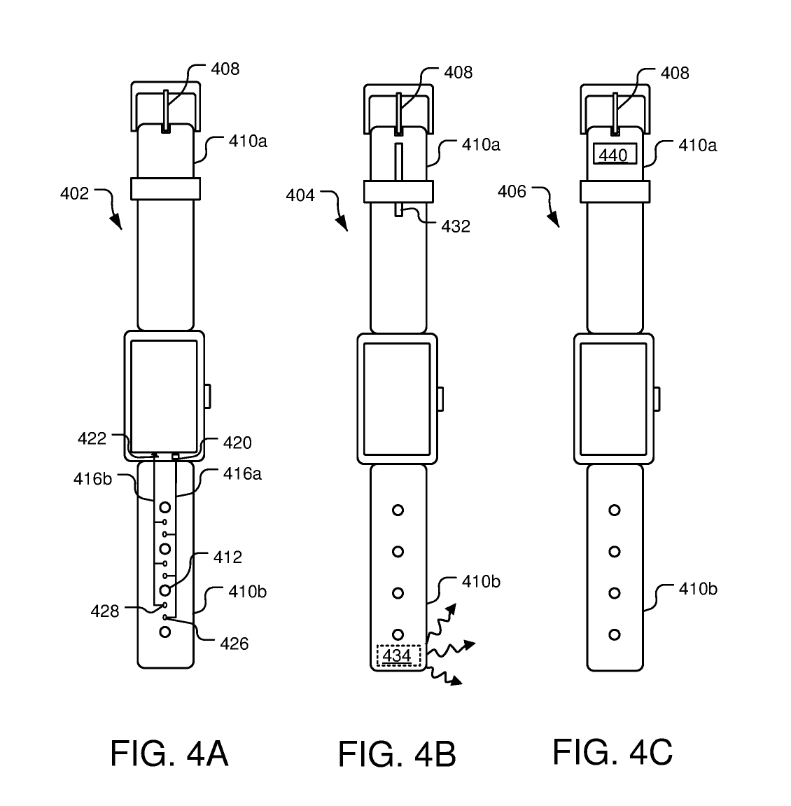

FIGS. 4A-4C illustrate examples of energy-efficient watch features that may be used to trigger location-based authentication. Various watches shown in FIGS. 4A, 4B, and 4C, respectively, represent one configuration of the mobile processing devices 100 and 200 shown in FIGS. 1 and 2, above. FIG. 4A illustrates a watch 402 with a low-energy buckle attachment detection feature. The watch 402 includes a band including a first end 410a and a second end 410b. The band includes a traditional buckle having a metal pin 408 on the first end 410a that is designed to rest within a corresponding hole (e.g., a hole 412) on the second end 410b. The second end 410b of the watch 402 includes embedded electrical components including an electrical path with a first half 416a and a second half 416b that do not connect to one another when the watch 402 is in an unbuckled state.

A current source 420 provides a current to the first half 416a of the electrical path, while the second half 416b of the electrical path connects to a ground point 422. When the watch 402 is unbuckled (as shown), current from the current source 420 is unable to flow to the ground point 422 and an input collected at a sampling point near the ground point 422 is zero. When, however, the first end 410a of the band is attached to the second end 410b of the band via the buckle, the metal pin 408 acts as a switch that completes a current loop between the first half 416a and the second half 416b of the electrical path (e.g., by electrically connecting exemplary end points 426 and 428), providing a non-zero input collectable at the sampling point proximal to the ground point 422.

In one implementation, the metal pin 408 is a pin with a very high impedance, allowing a detectable but relatively small current to flow into a processor of the watch 402. This detectable current may be so small that the natural discharge of the watch battery is significantly greater than the effective drain on a watch battery due to the small current flow. For example, a metal pin 408 with a high impedance may limit a current flow through the pin to at or less than 10 pA. In effect, the hardware shown in FIG. 4A provides an energy-efficient means of detecting attachment and detachment of the watch 402 to a user's wrist. When attachment is detected (e.g., when the user buckles the watch 402), the watch 402 may selectively request user authentication under some circumstances, such as when the user is in an unsecure location, while declining to request such authentication under other circumstances, such as when the user is in a secure location.

FIG. 4B illustrates another watch 404 with another low-energy buckle attachment detection feature. Common numerals are used to denote elements of the watch 404 that are the same or similar to those shown with respect to the watch 402. In contrast to watch 402 of FIG. 4A, the first end 410a of the band of the watch 404 includes an optical sensor 432. The optical sensor 432 is shown as an elongated strip but may assume other shapes, sizes, and positions in other implementations. The second end 410b of the band of the watch 404 includes a light emitter on an underside (not shown). An example position of the light emitter is shown by a dotted rectangle 434. In one implementation, the optical sensor 432 is tuned to detect the specific frequency of light emitted by the optical emitter. When the watch 404 is unbuckled (as shown), the optical sensor 432 does not detect light from the optical sensor and therefore provides a first input to a processor of the watch 404. When, however, the watch 404 is buckled, the optical sensor 432 detects the light from the optical sensor and provides a second different input to the processor of the watch.

FIG. 4C illustrates yet another watch 406 with another low-energy buckle attachment detection feature. Common numerals are used to denote elements of the watch 406 that are the same or similar to those shown with respect to the watch 402 and watch 404. The first end 410a of the band of the watch 406 includes a capacitance-based proximity sensor 440. The capacitance-based proximity sensor 440 may be tuned to detect the presence of a user's skin and/or the presence of the second end 410b of the band. For example, the second end 410b of the band may include a material with a high permittivity that causes a spike in a capacitance reading when the second end 410b of the band is placed adjacent to the first end of the band 410a (e.g., when the watch is attached to a user's wrist). Each of the mechanisms described above with respect to FIGS. 4A-4C may provide input that triggers location-based authentication, as described with respect to FIGS. 1-3, above.

FIG. 5 illustrates an example mobile processing device (e.g., a watch 502) that includes an energy-efficient dual display feature that facilitates continuous display of certain information at a low energy consumption rate. In particular, the watch 502 includes a low-energy-consumption display 504 and a high-energy-consumption display 506 that are independently powerable and operable to display different types of information.

As used herein, the terms “low-energy-consumption display” and “high-energy-consumption display” are intended to represent levels of energy consumption relative to one another. In one implementation, the low-energy-consumption display 504 is a non-light-emitting display, such as a display that utilizes e-ink technology. The high-energy-consumption display 506 is, in contrast, a light-emitting display, such as a display capable of displaying high resolution information at a range of different pixel colors (e.g., LCD, OLED, plasma).

In one implementation, the watch 502 includes a controller (not shown) that selectively toggles the high-energy-consumption display 506 between a display mode and sleep mode while the mobile processing device is powered on to save power. During the sleep mode, the high-energy-consumption display 506 does not emit light and does not display information on the screen. While in a “display mode,” light is emitted from the screen and information is displayed.

In one implementation, the controller of the watch 502 causes the high-energy-consumption display 506 to enter a sleep mode after a period of user inactivity. The high-energy-consumption display 506 may, for example, remain in the sleep mode until one or more recognized events occur. For example, the high-energy-consumption display 506 may transition from the sleep mode to a display mode responsive to a detected user action, such as when the user presses a button, taps a touchscreen, or flicks a wrist in a particular manner (e.g., as detectable by an accelerometer). In other implementations, the high-energy-consumption display 506 may automatically toggle between the sleep mode and the display mode when a physical configuration change of the watch is detected. For example, the high-energy-consumption display 506 may automatically exit the sleep mode and enter the display mode when the watch detects attachment or detachment of the watch band, such as described above with respect to any of FIGS. 4A-4C.

During the time that the watch 502 is powered on and the high-energy-consumption display 506 is selectively toggled between the sleep mode and the display mode, the low-energy-consumption display 504 may be continuously operated in a display mode. In one implementation, the low-energy-consumption display 504 is operated to continuously display the time so that the user can view the time without performing any affirmative action to awaken the high-energy-consumption display 506 from the sleep mode. In this sense, the user can easily decipher the time by glancing at the low-energy-consumption display 504, and the battery of the watch 502 remains comparable to devices that similarly toggle power levels of a high-energy-consumption display but do not include a low-energy-consumption display. This dual-display technology may be beneficially implemented in a variety of other battery-operated mobile devices including without limitation tablets, mobile phones, and laptop computers.

FIG. 6 illustrates another example mobile processing device (e.g., a watch 602) that includes a dual display feature that facilitates continuous display of information at a low energy consumption rate. Referring to view A, the watch 602 includes a compact design with a high-energy-consumption display 606 that is transparent and overlapping an underlying low-energy consumption display 604 (shown via a dotted rectangle). The low-energy-consumption display 604 and the high-energy-consumption display 606 that are independently powerable and operable to display different types of information.

In FIG. 6, the low-energy-consumption display 604 and the high-energy-consumption display 606 are aligned generally parallel to one another and are completely overlapping. In other implementations, the high-energy-consumption display 606 and the low-energy-consumption display 604 are partially overlapping.

In one implementation, the low-energy-consumption display 604 is a non-light-emitting display and the high-energy-consumption display 606 is a transparent light-emitting display. View B illustrates a particular example of such, where the low-energy-consumption display 604 utilizes e-ink technology and the high-energy-consumption display 606 is, in contrast, an organic light-emitting diode (OLED) display that includes an emissive electroluminescent layer that emits light in response to electrical current.

The e-ink technology of the low-energy-consumption display 604 utilizes an array of microcapsules (e.g., a microcapsule 612) sandwiched between a transparent electrode grid 614 and a supporting layer 616. Each of the microcapsules is a transparent cell that includes oppositely charged black and white pigment balls. For example, the black pigment balls may be negatively charged while the white pigment balls are positively charged. When the transparent electrode grid 614 applies a localized positive charge, the negatively charged black pigment balls migrate to the top of the corresponding microcapsules while the positively-charged white pigment balls are pushed away to the bottom of the corresponding microcapsules. The opposite effect occurs when a localized negative charge is applied. In this manner, information can be displayed in black and white by selectively controlling localized charge. The e-ink technology of the low-energy-consumption display 604 draws power when altering displayed information (e.g., by selectively applying localized charge), but does not draw any power while the display information is statically presented (e.g., no power is drawn when information is displayed in a stationary state).

In one implementation, the OLED technology of the high-energy-consumption display 606 includes a number of cells that each include a conductive layer 618 adjacent to an emissive layer 620 of organic material that are both situated between a transparent cathode layer 622 and a transparent anode layer 624. The emissive layer 620 may include a series of thin organic films. An applied voltage difference between the transparent anode layer 624 and the transparent cathode layer 622 causes a current of electrons to flow into the emissive layer 620, ultimately resulting in the emission of radiation in the visible range.

In other implementations, both the low-energy-consumption display 604 and the high-energy-consumption display 606 are light-emitting displays. For example, low-energy-consumption display 604 may be a light-emitting display that utilizes less power than the high-energy-consumption display 606, such as by presenting information at a lower resolution.

In one implementation, the watch 602 includes a controller (not shown) that selectively toggles a power level of the high-energy-consumption display 606 between a display mode and sleep mode while the watch 602 is powered on. For example, the high-energy-consumption display 606 panel may be placed into a sleep mode to save power during times of inactivity when the user is not actively interacting with the watch 602 or using the watch 602 for any purpose other than to display information. Because the high-energy-consumption display 606 is transparent, information presented via the low-energy-consumption display 604 is visible to the user through the high-energy-consumption display 606. Thus, the low-energy-consumption display 604 may be used to continuously display some information (such as time) regardless of the power state of the high-energy-consumption display 606.

In other implementations, both the low-energy-consumption display 604 and the high-energy-consumption display 606 are light-emitting displays. For example, low-energy-consumption display 604 may be a light-emitting display that utilizes less power than the high-energy-consumption display 606, such as by presenting information at a lower resolution.

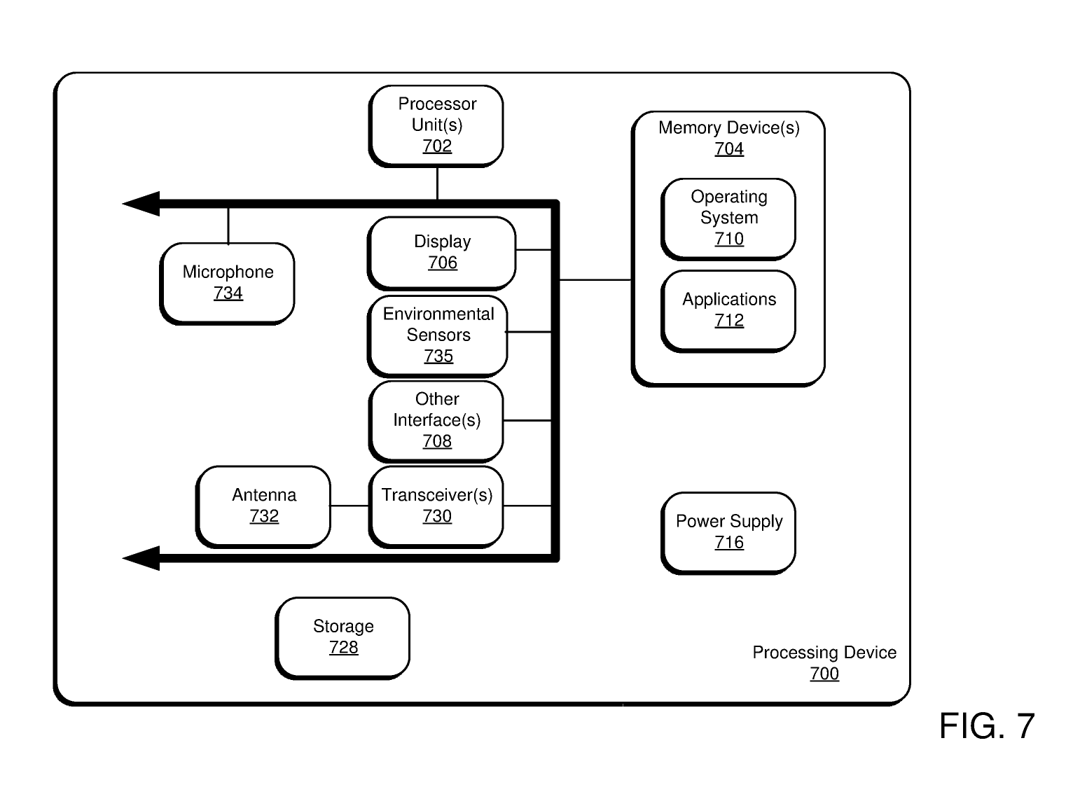

FIG. 7 illustrates an example schematic of a mobile processing device 700 suitable for implementing aspects of the disclosed technology. The example mobile processing device 700 includes one or more processor units 702, one or more memory devices 704, a display 706, and other interfaces 708 (e.g., buttons). The memory 704 generally includes both volatile memory (e.g., RAM) and non-volatile memory (e.g., flash memory). An operating system 710, such as the Microsoft Windows® operating system, the Microsoft Windows® Phone operating system or a specific operating system designed for a gaming device, resides in the memory 704 and is executed by the processor unit(s) 702, although it should be understood that other operating systems may be employed.

One or more applications 712, such as a location-based access controller, location tracker, and device mode detector are loaded in the memory device 704 and executed on the operating system 710 by the processor(s) 702. The applications 712 may receive input from the display 706 and/or environmental sensors 735 (e.g., an accelerometer, touch sensors, imaging sensors, proximity sensors) included in the mobile processing device 700. The example mobile processing device 700 includes a power supply 716, which is powered by one or more batteries or other power sources and which provides power to other components of the mobile processing device 700. The power supply 716 may also be connected to an external power source that overrides or recharges the built-in batteries or other power sources.

The mobile processing device 700 includes one or more communication transceivers 730 and an antenna 732 to provide network connectivity (e.g., a mobile phone network, Wi-Fi®, Bluetooth®). The mobile processing device 700 may also include various other components, such as a positioning system (e.g., a global positioning satellite transceiver), one or more accelerometers, one or more cameras, an audio interface (e.g., a microphone 734, an audio amplifier and speaker and/or audio jack), and additional storage 728. Other configurations may also be employed.

In an example implementation, a mobile operating system, various applications (including a stylus position detection engine) and other modules and services may be embodied by instructions stored in memory 704 and/or storage devices 728 and processed by the processing unit(s) 702. The memory 704 may be memory of a host device or of an accessory that couples to a host. Some or all aspects of the mobile processing device described with respect to FIGS. 1-4, above, may be saved in memory internal or external to the mobile processing device 700 and executed by a processor internal or external to the mobile processing device 700.

The mobile processing device 700 may include a variety of tangible processor-readable storage media and intangible processor-readable communication signals. Tangible processor-readable storage can include both volatile and nonvolatile storage media, removable and non-removable storage media. Tangible processor-readable storage media excludes intangible and transitory communications signals and includes volatile and nonvolatile, removable and non-removable storage media implemented in any method or technology for storage of information such as computer readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the mobile processing device 700. In contrast to tangible processor-readable storage media, intangible processor-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example device includes a location detector stored in memory and executable by a processor to identify a current device location. The device also includes a location-based access controller stored in the memory and executable by the processor to determine whether the current device location satisfies at least one predefined secure location criteria and selectively preserve or disable a current user authentication session based on the determination.

In another example device of any preceding device, the location-based access controller selectively preserves the current user authentication session when the current device location corresponds to a secure location.

In another example device of any preceding device, the location-based access controller selectively disables the current user authentication session and prompts a user for an authentication credential when the current device location does not correspond to a secure location stored in the memory.

In still another example device of any preceding device, the location-based access controller selectively preserves or disables the current user authentication session responsive to a detected change in location satisfying a predefined location change criteria.

In another example device of any preceding device, the location-based access controller selectively preserves or disables the current user authentication session responsive to a detected change in a physical configuration of the electronic device.

In another example device of any preceding device, the device is a watch and the detected change in the physical configuration is a change between a secured position and an unsecured position of a wearable band that provides a first electrical input to a processor when in the secured position and a second electrical input to the processor when in the unsecured position.

In another example device of any preceding device with a wearable band, the wearable band includes a buckle with a high impedance pin that provides a current flow into the electronic device when the wearable band is in the secured position and does not provide the current flow into the device when the wearable band is in the unsecured position.

In another example device of any preceding device with a wearable band, the wearable band includes a light emitter proximal a first end and a light detector proximal a second end and the first electrical input is provided to the device when the light detector detects light from the light emitter.

In another example device of any preceding device with a wearable band, the wearable band includes a capacitance-based proximity sensor that selectively provides the first electrical input and the second electrical input based on detected proximity of a user.

An example device includes a means for identifying a current location of an electronic device; a means for determining whether the current location satisfies at least one predefined secure location criteria; and a means for selectively preserving or disabling a current user authentication session of the electronic device based on the determination.

An example method comprises identifying a current location of an electronic device, determining whether the current location satisfies at least one predefined secure location criteria, and selectively preserving or disabling a current user authentication session of the electronic device based on the determination.

In another example method of any preceding method, the method further comprises comparing the current location of the electronic device to a plurality of stored secure locations, selectively preserving or disabling the current user authentication session includes selectively preserving the current user authentication session when the current device location corresponds to at least one of the plurality of stored secure locations and selectively disabling the current user authentication session when the current device location does not correspond to any of the plurality of stored secure locations.

In another example method of any preceding method, the method further comprises selectively preserving or disabling the current user authentication session further comprises selectively preserving or disabling the current user authentication session responsive to a detected change in location satisfying a predefined location change criteria.

In another example method of any preceding method, the method further comprises selectively preserving or disabling the current user authentication session responsive to a detected change in a physical configuration of the electronic device.

In another example method of any preceding method, the method further comprises selectively preserving or disabling the current user authentication session responsive to a detected change in a physical configuration of the electronic device, where the physical configuration is of a wearable band that provides a first electrical input to a processor when in a secure position and a second electrical input to the processor when in an unsecured position.

In another example method of any preceding method, the method further comprises selectively preserving or disabling the current user authentication session responsive to a detected change in a physical configuration of a wearable band, wherein the wearable band includes a buckle with a high impedance pin that provides a first current flow into the device when the wearable band is in the secured position and a does not provide the current flow into the device when the wearable band is in the unsecured position.

An example electronic device includes a location tracker stored in memory and executable by a processor to determine a current location of the electronic device, and further includes a location-based access controller stored in the memory and executable by the processor to determine whether the current device location satisfies at least one predefined secure location criteria and selectively relaxes a security feature of the electronic device responsive to the determination.

In an example electronic device of any preceding device, the location-based access controller selectively relaxes the security feature by preventing interruption of a current user authentication session while the at least one predefined secure location criteria remains satisfied.

In another example electronic device of any preceding device, the location-based access controller is further executable to disable a current user authentication session responsive to a determination that the current device location does not satisfy the at least one predefined secure location criteria.

In another example electronic device of any preceding device, the at least one predefined secure location criteria is satisfied when the current device location corresponds to a secure location saved in the memory.

In another example electronic device of any preceding device, the location-based access controller selectively preserves or disables the current user authentication session responsive to a detected change in location satisfying a predefined location change criteria.

An example electronic device disclosed herein includes a low-energy-consumption display configured to display first information and a transparent high-energy-consumption display positioned with an area overlapping the low-energy-consumption display such that the first information is viewable through the area when the transparent high-energy-consumption display is in a sleep mode.

In another example electronic device of any preceding device, the transparent high-energy-consumption display is a light-emitting display and the low-energy-consumption display is a non-light-emitting display.

In another example electronic device of any preceding device, the transparent high-energy-consumption display is an organic light emitting diode (OLED) display.

In another example electronic device of any preceding device, the low-energy-consumption display is an e-ink display.

In another example electronic device of any preceding device, the transparent high-energy-consumption display and the low-energy-consumption display are parallel to one another.

In another example electronic device of any preceding device, the electronic device further includes a device mode detector and a high-energy display controller that are stored in memory and executable by a processor. The device mode detector is configured to detect a change in a physical configuration of the electronic device, and the high-energy display controller is configured to selectively alter a power state of the high-energy-consumption display responsive to the detected change in the physical configuration.

In another example electronic device of any preceding device, the electronic device is a watch and the device mode detector is configured to detect a change between a secured position and an unsecured position of a wearable band.

Another electronic device disclosed herein includes a non-light-emitting display that displays first information and a light-emitting display that is selectively toggled between a display mode and a sleep mode while the first information is displayed on the non-light-emitting display.

In another example electronic device of any preceding device, the light-emitting display is an organic light emitting diode (OLED) display.

In another example electronic device of any preceding device, the non-light-emitting display is an e-ink display.

In another example electronic device of any preceding device, the light-emitting display is transparent and at least partially overlapping the non-light-emitting display.

In another example electronic device of any preceding device, the light-emitting display and the non-light-emitting display are adjacent to one another and non-overlapping.

In another example electronic device of any preceding device, the first information includes a time of day.

An example method comprises displaying first information on a non-light-emitting display of an electronic device and displaying second information on a light-emitting display of the electronic device positioned to have an area overlapping the non-light emitting display through which the first information is viewable.

In another example method of any preceding method, the light-emitting display is an organic light emitting diode (OLED) display.

In another example method of any preceding method, the light-emitting display is an e-ink display.

In another example method of any preceding method, the method further comprises displaying the first information on the non-light emitting display while the light-emitting display is in a sleep mode.

In another example method of any preceding method, the method further comprises detecting a change in a physical configuration of the electronic device while the light-emitting display is in the sleep mode and selectively placing the light-emitting display into the display mode responsive to the detected change in the physical configuration.

In another example method of any preceding method, the electronic device is a watch and detecting the change in the physical configuration of the electronic device further comprises detecting a change between a secured position and an unsecured position of a wearable band.

In another example method of any preceding method, the first information includes a time of day.

An electronic device disclosed herein includes a means for displaying first information on a non-light-emitting display of an electronic device and a means for displaying second information on a light-emitting display of the electronic device positioned to have an area overlapping the non-light emitting display through which the first information is viewable.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A device comprising:
a location detector stored in memory and executable by a processor to identify a current device location;
a location-based access controller stored in the memory and executable by the processor to determine whether the current device location satisfies at least one predefined secure location criteria and selectively preserve or disable a current user authentication session based on the determination.

2. The device of claim 1, wherein the location-based access controller selectively preserves the current user authentication session when the current device location corresponds to a secure location stored in the memory.

3. The device of claim 1, wherein the location-based access controller selectively disables the current user authentication session and prompts a user for an authentication credential when the current device location does not correspond to a secure location stored in the memory.

4. The device of claim 1, wherein the location-based access controller selectively preserves or disables the current user authentication session responsive to a detected change in location satisfying a predefined location change criteria.

5. The device of claim 1, wherein the location-based access controller selectively preserves or disables the current user authentication session responsive to a detected change in a physical configuration of the device.

6. The device of claim 5, wherein the device is a watch and the detected change in the physical configuration is a change between a secured position and an unsecured position of a wearable band that provides a first electrical input to a processor when in the secured position and a second electrical input to the processor when in the unsecured position.

7. The device of claim 6, wherein the wearable band includes a buckle with a high impedance pin that provides a current flow into the device when the wearable band is in the secured position and does not provide the current flow into the device when the wearable band is in the unsecured position.

8. The device of claim 6, wherein the wearable band includes a light emitter proximal a first end and a light detector proximal a second end and the first electrical input is provided to the device when the light detector detects light from the light emitter.

9. The device of claim 6, wherein the wearable band includes a capacitance-based proximity sensor that selectively provides the first electrical input and the second electrical input based on detected proximity of a user.

10. A method comprising:
identifying a current location of an electronic device;
determining whether the current location satisfies at least one predefined secure location criteria; and
selectively preserving or disabling a current user authentication session of the electronic device based the determination.

11. The method of claim 10, further comprising:
comparing the current location of the electronic device to a plurality of stored secure locations, and wherein selectively preserving or disabling the current user authentication session includes:
selectively preserving the current user authentication session when the current device location corresponds to at least one of the plurality of stored secure locations; and
selectively disabling the current user authentication session when the current device location does not correspond to any of the plurality of stored secure locations.

12. The method of claim 10, wherein selectively preserving or disabling the current user authentication session is performed responsive to a detected change in location satisfying a predefined location change criteria.

13. The one method of claim 10, wherein selectively preserving or disabling the current user authentication session is performed responsive to a detected change in a physical configuration of the electronic device.

14. The method of claim 10, wherein the detected change in the physical configuration is a change in a a wearable band that provides a first electrical input to a processor when in a secure position and a second electrical input to the processor when in an unsecured position.

15. The method of claim 14, wherein the wearable band includes a buckle with a high impedance pin that provides a current flow into the electronic device when the wearable band is in the secured position and does not provide the current flow into the electronic device when the wearable band is in the unsecured position.

16. An electronic device comprising:
a location tracker stored in memory and executable by a processor to determine a current location of the electronic device; and
a location-based access controller stored in the memory and executable by the processor to:
determine whether the current device location satisfies at least one predefined secure location criteria; and
selectively relax a security feature of the electronic device responsive to the determination.

17. The electronic device of claim 16, wherein the location-based access controller selectively relaxes the security feature by preventing interruption of a current user authentication session while the at least one predefined secure location criteria remains satisfied.

18. The electronic device of claim 16, wherein the location-based access controller is further executable to disable a current user authentication session responsive to a determination that the current device location does not satisfy the at least one predefined secure location criteria.

19. The electronic device of claim 16, wherein the at least one predefined secure location criteria is satisfied when the current device location corresponds to a secure location saved in the memory.

20. The electronic device of claim 16, wherein the location-based access controller selectively preserves or disables the current user authentication session responsive to a detected change in location satisfying a predefined location change criteria.
